(19) United States
(12) Patent Application Publication
(10) Pub. No.: US 2013/0191188 A1
(43) Pub. Date: Jul. 25, 2013

(54) METHOD FOR ENERGY BENCHMARKING AND DIAGNOSIS THROUGH OPTIMIZATION AND A SYSTEM THEREOF

(71) Applicant: ABB RESEARCH LTD., Zurich (CH)

(72) Inventors: Tarun Prakash MATHUR, Bangalore (IN); Naveen BHUTANI, Rohini (IN)

(73) Assignee: ABB RESEARCH LTD., Zurich (CH)

(21) Appl. No.: 13/783,813

(22) Filed: Mar. 4, 2013

Related U.S. Application Data
(63) Continuation of application No. PCT/IB2011/001513, filed on Jun. 29, 2011.

(30) Foreign Application Priority Data
Sep. 3, 2010 (IN) 2558/CHE/2010

(51) Int. Cl. G06Q 10/06

(52) U.S. Cl. CPC G06Q 10/06393
USPC 705/7.39

(57) ABSTRACT

Exemplary embodiments relate to a method for energy benchmarking a process plant having at least one component, and for diagnosing the process plant thereof. The method includes adapting a process model for the process plant determining energy consumption of the process plant based on design conditions or current operating conditions or both and performing optimization for estimating the energy benchmark. Further, the method also includes calculating indices for gap analysis and diagnosing the gap between the current energy consumption of the process plant and the estimated energy benchmark.

### RELATED APPLICATION(S)

This application claims priority as a continuation application under 35 U.S.C. §120 to PCT/IB2011/001513, which was filed as an International Application on Jun. 29, 2011 designating the U.S., and which claims priority to Indian Application No. 2558/CHE/2010 filed in India on Sep. 3, 2010. The entire content of each related application is hereby incorporated by reference.

### FIELD

The disclosure relates to a method and system for energy benchmarking in a process plant, and more particularly to energy benchmarking and diagnosis through optimization.

### BACKGROUND INFORMATION

In a known process industry or plant, energy is consumed in various forms like steam, electricity, or other forms as desired for its functioning and for producing the yield or product. The consumption of energy in a process plant should be monitored and compared against a reference value and thereupon contribute towards improving the efficiency of the plant. The method of obtaining the reference value is termed as benchmarking.

Currently, benchmarking is done using several methods, more popular among them are a statistical method and a thermodynamic method. In the statistical method, data relating to plant operation, e.g., the historical operating data and patterns of energy consumption corresponding to multiple plants employing similar process technology are obtained and analyzed for the most energy efficient one and is being set as the benchmark. In the thermodynamic method, the best possible energy efficiency of the plant is computed theoretically and is set as the benchmark.

Both the aforementioned statistical and thermodynamic methods have notable limitations. The statistical method can call for recent and extensive data from multiple plants and as such does not take into account the effects of the operating conditions, external factors such as climate, the age of the plant, the scale of the operation, or other factors as desired, on the performance of the plant. In known implementations, a plant which is energy inefficient can be set as a benchmark due to the limited survey of plants and/or limited availability of plants during the survey. Further, even the plant considered to be the most energy efficient can be farther away from its best/design performance, and can specify improvements that cannot be predicted by this method. On the other hand, the thermodynamic method often sets the benchmark for energy efficiency which is unrealistic due to the fact that it does not give due consideration for practical limitations in the processes such as constraints purporting to quality, design, age of plant/equipment etc.

Moreover, in the current practice, though the energy benchmark is set, the same cannot be realized in the plant due to the practical limitations that persist and that are not accounted for in setting the benchmark. Hence, the energy benchmark should be set considering the practical limitations of the plant and provide a solution that enables the plant to work closer or reach the energy benchmark that been set.

### SUMMARY

An exemplary method for energy benchmarking a process plant having at least one component is disclosed, the method comprising: adapting a process model for said process plant; determining an energy consumption of the process plant based on at least one of design conditions and current operating conditions; and performing an optimization of the energy consumption to estimate an energy benchmark.

An exemplary method for energy benchmarking a process plant having at least one component and for diagnosing said process plant is disclosed, the method comprising: adapting a process model for said process plant; determining an energy consumption of said process plant based on at least one of design conditions and current operating conditions; performing an optimization of the energy consumption to estimate an energy benchmark; calculating indices for gap analysis; and diagnosing a gap between said current energy consumption of said process plant and said estimated energy benchmark.

An exemplary system for energy benchmarking and providing a diagnosis of a process plant having at least one component is disclosed, the system comprising: a processor configured to execute a process model of said process plant; an energy consumption determination component to determine energy consumption of said process plant based on at least one of design conditions and current operating conditions; an optimization module to perform optimization for estimating energy benchmark; and a diagnosis module to calculate indices for gap analysis and diagnose the gap between said current energy consumption said process plant and said estimated energy benchmark.

### BRIEF DESCRIPTION OF THE DRAWINGS

With reference to the accompanying drawings in which:

FIG. 1 shows a schematic representation of energy benchmarking and diagnosis in accordance with an exemplary embodiment of the disclosure.

FIG. 2 shows a simplified material flow diagram for a Basic Oxygen Furnace in accordance with an exemplary embodiment of the present disclosure.

### DETAILED DESCRIPTION

Exemplary embodiments of the present disclosure provide a method for energy benchmarking a process plant, where the said energy benchmarking is realistic.

Exemplary embodiments disclosed herein also provide a method for energy benchmarking which suggests recommendations that enable the process plant to improve with regard to energy consumption.

Exemplary embodiments of the present disclosure provide a system for and capable of energy benchmarking a process plant.

In accordance with an exemplary embodiment of the disclosure a method for energy benchmarking for process plant having at least one component (e.g., equipment) is disclosed. The method including the steps of: a) adapting a process model for the process plant. Adapting the process model herein refers to one or more of developing a process model for a process plant or using an existing process model without alteration or adapting an existing process model to suit the process plant. Adapting the process model includes relating the energy consumption of the process plant to the process conditions. The steps also include b) determining energy consumption of the process plant. The energy consumption is determined based on design conditions and/or current operating conditions. Design conditions can include and are not limited to values of the process plant and corresponding to yield or energy coefficients or both. Current operating conditions can include and are not limited to current operating values of the process variables of the process plant and correspond to yield or energy coefficients or both. The method includes the step of c) performing optimization for estimating energy benchmark. Performing optimization for estimating energy benchmark further includes using constraints of the equipment or the process plant or both for estimating the energy benchmark.

In accordance with another exemplary embodiment of the disclosure, a method for energy benchmarking a process plant having at least one component (e.g., equipment), and for diagnosing the process plant thereof is disclosed. The exemplary method includes the steps of the method described herein above. Additionally, the method comprises the steps d) calculating indices for gap analysis; and e) diagnosing the gap between the current energy consumption of the process plant and the estimated energy benchmark. Diagnosing is done using the indices for reducing the gap between the current energy consumption of the process plant and the estimated energy benchmark. Also, diagnosing includes comparing the values purporting to yield and/or energy coefficients of the design conditions and/or of the current operating conditions and/or that of current process variables, corresponding with the values of yield or energy coefficients or process variables obtained through optimization. Diagnosing further refers to controlling the equipment and/or the process plant based on the comparison and improvement thereupon through maintenance and/or operation of the equipment and/or the process plant. It is to be construed that diagnosing mentioned herein is not restrictive to that been stated here above.

According to yet another exemplary embodiment of the disclosure there is provided a system for energy benchmarking for a process plant having at least one component (e.g., equipment), and diagnosis thereof. The method of performing energy benchmarking and diagnosis as mentioned above is in accordance with the disclosure. The exemplary system of the present disclosure is capable of and for performing the method according to the disclosure. The system of the disclosure comprises: a process model of the said process plant; an energy consumption determination component to determine energy consumption of the process plant based on design conditions and/or current operating conditions; an optimization module to perform optimization for estimating energy benchmark; and a diagnosis module to calculate indices for gap analysis and accordingly to diagnose the gap between the current energy consumption of the process plant and the estimated energy benchmark. The indices for gap analysis can be calculated in a separate module (e.g., processor) either explicitly or implicitly. The system can also include one or more suitable controllers (e.g., processor) for the purpose of diagnosing or the like by way of controlling the equipment and/or the process plant.

The disclosure is described hereinafter with reference to an exemplary embodiment for better understanding and it is non exhaustive in nature. The disclosure relates to a method for energy benchmarking of process plant and also to perform diagnosis thereto in relation to the energy benchmarking.

It is to be understood that the known practices do not give due consideration for the constraints prevalent with respect to the equipment and/or the process plant. It would be appreciable if energy benchmarking is done in a realistic manner taking into considerations these drawbacks, and the disclosure provides a solution to this effect.

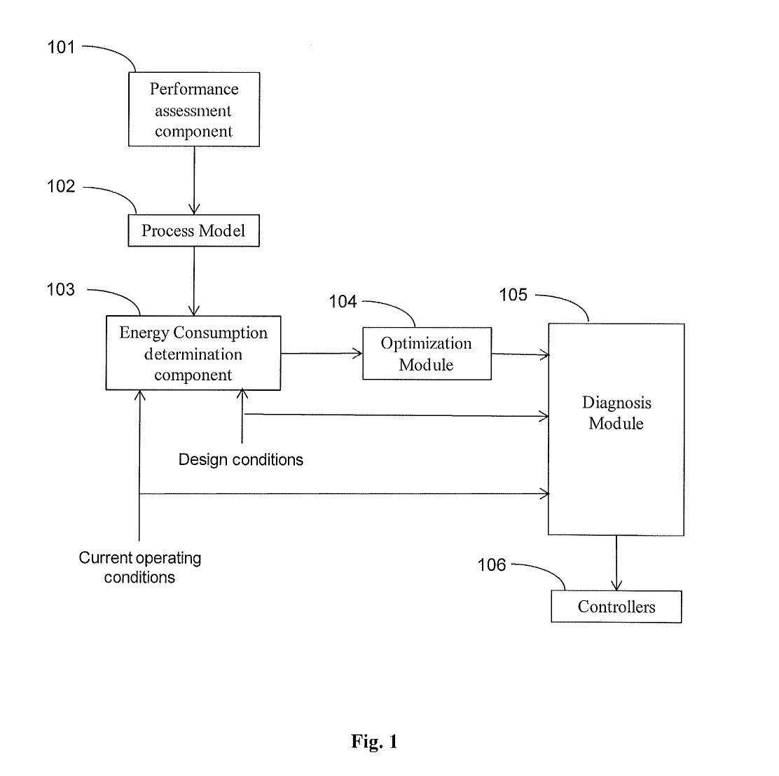

The disclosure is further explained with reference to an exemplary schematic shown in FIG. 1. FIG. 1 shows a schematic representation of energy benchmarking and diagnosis in accordance with an exemplary embodiment of the disclosure. The performance assessment component (101) (e.g., a computer processor) performs the assessment of the performance relating to equipment/process plant, based on the assessment it is determined whether energy benchmarking needs to be performed for any specified equipment/process plant. This can be done in multiple ways, some of which include, based on the process knowledge of the operator, and comparison of actual performance of the equipment/process plant with corresponding design performance. Accordingly, the need for energy benchmark and/or diagnosis thereafter is decided upon. However, this step of performance assessment is optional and is not mandate.

A process model (102) is developed or an existing process model is used as such or an existing model is adapted to suit the process plant. One or more of this refers to adapting a process model for the process plant in the context of the disclosure. Adapting the process model means relating the energy consumption of the process plant to the process conditions. The energy consumption is expressed as a function of process variables, yield and energy coefficients. The values of the yield and coefficients can again be a function of process variables. The simplified equations are given as below:

Energy consumption=f(process variables,yield,energy coefficients) (1)

Yield=f(process variables) (2)

Energy coefficients=f(process variables) (3)

The energy consumption is determined by the energy consumption determination component (103) (e.g., a computer processor) with respect to design conditions and current operating conditions of the process plant and is represented as E_{des} and E_{current}, respectively. The design condition includes design values of the process plant that corresponds to yield and/or energy coefficients. Similarly, current operating conditions include current operating values of the process variables pertaining to the process plant and that corresponding to yield and/or energy coefficients. The values of yield and energy coefficient corresponding to design conditions are represented as Yield_{des} and EnergyCoeff_{des}, respectively. The values of yield and energy coefficient corresponding to current operating conditions are represented as Yield_{current} and EnergyCoeff_{current}, respectively.

Optimization for estimating energy benchmark for the process plant is performed by the optimization module (104) (e.g., a computer processor). The optimal values of the process variables, yield and energy coefficients are found and are represented as Process variablesₒₚₜ, Yieldₒₚₜ and EnergyCoeffₒₚₜ, respectively. Optimization is performed to find out (e.g., determine) the optimal energy consumption for the process plant, accounting for the practical constraints on the equipment and/or the process plant. The optimal energy consumption obtained under the realistic constraints is the energy benchmark estimated for the process plant.

Indices k₁ to k₅ are calculated for gap analysis. These indices are used in performing diagnosis for the gap between the current energy consumption of the process plant and the estimated energy benchmark. Equations relating to finding k₁ to k₅ are shown below:

$$\begin{matrix}{k}_{1} = \frac{( {Yield}_{opt} - {Yield}_{current} )}{{Yield}_{opt}} & ( 4 ) \\ {k}_{2} = \frac{( {Yield}_{des} - {Yield}_{opt} )}{{Yield}_{des}} & ( 5 ) \\ {k}_{3} = \frac{( {EnergyCoeff}_{opt} - {EnergyCoeff}_{current} )}{{EnergyCoeff}_{opt}} & ( 6 ) \\ {k}_{4} = \frac{( {EnergyCoeff}_{des} - {EnergyCoeff}_{opt} )}{{EnergyCoeff}_{des}} & ( 7 ) \\ {k}_{5} = \frac{\sqrt{{\sum }_{i = 1}^{i = p} {[ {( ProcessVariable )}_{actual , t} - {( ProcessVariable )}_{opt} ]}^{2}}}{{( ProcessVariable )}_{opt}} & ( 8 )\end{matrix}$$

Diagnosis for the gap between the current energy consumption of the process plant and the estimated energy benchmark is performed by the diagnosis module (105) (e.g., computer processor). As a part of it, an approach to reduce the gap between the current energy consumption of the process plant and the estimated energy benchmark is deduced, where recommendation for reduction of such gap is made.

Indices k₁ or k₃ being greater than a predefined value signifies that the current yield or energy coefficient, respectively, of the process plant is far from their corresponding optimal values. This means that there is a need for improvement through operation for the said process plant in order to improve the energy consumption of the process plant and bringing it close to or at the energy benchmark that has been estimated. To attain this result, the process plant is operated as per the values of process variables obtained from optimization (Process variablesₒₚₜ).

Similarly, when indices k₂ or k₄ being greater than a predefined values signifies that the optimal values of the yield or energy coefficient, respectively, of the process plant within the given operational constraints is far from their corresponding design values. This could be due to the aging of the process plant and indicates that maintenance should be performed. Accordingly, improvement through maintenance can be carried out to reach the estimated energy benchmark. Alternatively, k₂ or k₄ can be greater than a predefined value due to some process variables hitting their upper and lower bounds of values in the optimization solution. Based on the process knowledge, the bounds can be changed and optimization performed with the changed bounds. The optimization results thus obtained can further be analyzed by computing the indices again.

Index k₅ when being greater than a predefined value signifies that the current process or equipment is not operated at the optimal values and that there is a variance of the current operating values of process variables from its corresponding optimal values. Further, the variance or offset can be reduced by enabling the process plant to operate at optimal values and thereby at an estimated energy benchmark. The improvements sought through operation can be achieved accordingly by having appropriate control of the process plant through suitable controllers (106) or the like.

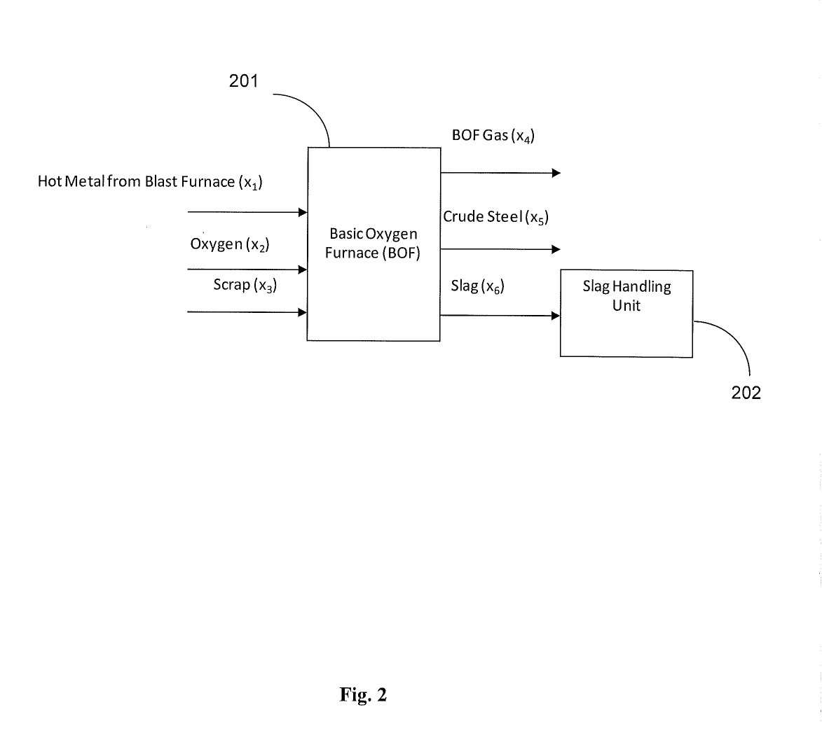

Exemplary embodiments of the present disclosure are further described in specificity to the Basic Oxygen Furnace (BOF) in a steel making plant. FIG. 2 shows a simplified material flow diagram for a Basic Oxygen Furnace in accordance with an exemplary embodiment of the present disclosure. The BOF (201) has inputs of hot metal from the blast furnace, oxygen, and scrap on an upstream side. The outputs which are on a downstream side of the BOF (201) include BOF gas, crude steel, and slag. The process variables associated correspondingly with the hot metal from the blast furnace, oxygen, scrap, BOF gas, crude steel, and slag are their mass flow rates x₁, x₂, x₃, x₄, x₅, and x₆, respectively.

The objective function (z) herein for the BOF is its cost function and is formulated as follows:

Cost=Upstream energy cost+Downstream energy cost+Utility cost+Electricity cost−Cost of additional energy generated in the process (9)

BOF Cost=(Energy Cost of Producing Material Entering the BOF+Energy Cost of producing pure Oxygen)+(Energy Cost of slag handling+Energy Cost of cleaning BOF Gas)+(Utility Cost of the BOF)+(Electrical Energy Cost for the surrounding electrical equipment)−(Equivalent Energy Cost of BOF Gas) (10)

z=BOF Cost=(x₁C₁+x₂C₂)+(x₄C₄+x₆C₆)+x₅C_{U5}+x₅C_{E5}−x₄C_{R4} (11)

Where

Upstream energy cost=Energy Cost of Producing Material Entering the BOF+Energy Cost of producing pure Oxygen;
Downstream energy cost=Energy Cost of slag handling+Energy Cost of cleaning BOF Gas;
Electricity cost=Electrical Energy Cost for the surrounding electrical equipment;
Cost of additional energy generated in the process=Equivalent Energy Cost of BOF Gas;
x₁, x₂, x₃, x₄, x₅, x₆=Mass Flow rate of hot metal from the Blast Furnace, oxygen, scrap, BOF gas, crude steel, and slag respectively;
C₁=Energy cost of producing per unit hot metal in the Blast Furnace;
C₂=Energy cost of producing per unit oxygen that is fed to the BOF;
C₄=Energy cost of cleaning per unit of BOF gas;
C_{R4}=Energy cost of recoverable energy per unit of BOF gas;
C_{U5}=Equivalent Energy Cost of utility (steam, water) consumed per unit of output steel production;
C_{E5}=Electrical Energy Cost consumed per unit of output steel production in the BOF; and
C₆=Energy Cost of slag handling per unit of the slag mass flow

Equation (11) is equivalent to equation (1) for representing energy consumption in a process, namely, BOF here. Energy consumption is a function of process variables, namely, mass flow rate of hot metal from the Blast Furnace, oxygen, scrap, BOF gas, crude steel, slag, represented by x₁ to x₆ respectively. Cᵢ are the energy coefficients as mentioned in equation (1).

BOF gas can be utilized as a fuel in other furnaces in the plant. The slag is handled in the slag handling unit (202). C_{R4} is the cost associated with chemical (or thermal) energy in BOF gas and can be calculated using heating value of the gas for a standard composition of BOF gas. It is necessary that the energy values should either be converted to equivalent thermal energy or electrical energy to formulate a cost function for optimization. The optimization will have constraints related to design or operational limitations that should be included in the formulation. Some of these constraints are as follows:

Mass balance on BOF, which is written by assuming yield for production of steel from hot metal and scrap.

x₅=Yield*(x₁+x₃) (12)

x₅ can be replaced in equation (11) with this equation, hereby, making energy consumption in the BOF a function of Yield, as mentioned in equation (1).

The capacity constraint on the BOF process is as follows:

x₅≦X_{Max}

In some plants there can be an operational constraint (best practice) that the hot metal and scrap are fed at a minimum ratio of 4:1, e.g., x₁≧4x₂.

There can be additional constraints based on the demand of output steel, constraints on the flux material that are added along with the scrap, etc. The optimization criterion is to minimize the cost by manipulating the metal and scrap charge within the specified constraints.

The optimization with the cost function given in equation 11, results in minimum energy consumption for BOF within the specified process constraints. The output of the mathematical optimization is optimal process variables values, x₁ₒₚₜ to X₆ₒₚₜ, corresponding to minimum energy consumption. Yield and energy coefficients can be a function of process variables themselves. For example, the production (process variable), below the design capacity usually results in higher energy consumption and lower yield. Such relations (equation 2 and 3) can be provided by OEMs or can be construed from historical data of the plant, e.g. yield data for different production values taken together can give mathematical relation between yield and production.

Therefore, using the above mentioned yield and energy coefficient relations, x₁ₒₚₜ to x₆ₒₚₜ, values can be used to calculate Yieldₒₚₜ and EnergyCoeffₒₚₜ.

All the design process variables, yield and energy coefficient values can be available from the OEM.

The next step is to compare the optimal values of the process variables, yield and energy coefficients, as explained above, with the design and the current values.

In ideal operation, KPI−1 (k₁ in equation 4) is ‘0’ suggesting that the process is already running at optimal conditions. If the yield in the current operation (Yield_{curent}) of BOF is lower than the optimal yield (Yieldₒₚₜ), this results in KPI−1 being higher than the ideal value of ‘0’. As already described, this calls for improvement in operation to bring it closer to operation, e.g. oxygen flow rate in the BOF is 1000 Nm³/hr currently and the optimal rate is 1500 Nm³/hr, the control system set point for oxygen mass flow rate should be set to the optimal value, along with all the other process variables. Similar analysis holds true for an energy coefficient (e.g., k₃ in equation 6).

Index k₂ is a measure of gap between the current operation and the design conditions. If k₂ is higher than a predefined benchmark (e.g., 20% away from design conditions), this is due to the aging of the plant and its equipment. This result indicates that maintenance or an upgrade of the equipment could be warranted, e.g., the control valve can have issues, such as sticking, friction, etc., and should be changed for smooth operation. Similar analysis holds true for energy coefficients, as in equation 4.

In some cases, the process variables in current operation are closer to optimal values, but still the energy consumption is higher than that at the design conditions or as predicted by optimization. This can happen if the mean value of the process variable is close to its optimal value but there are large variations around the mean value, resulting in performance degradation of the process. For example, an oxygen flow set point in the control system can be 1500, exactly as its optimal value but the instantaneous value of the variables results in 20% standard deviation which can be captured in equation 5. This KPI (k₅) being higher than a predefined benchmark suggests that the control system performance is poor and should undergo proper tuning of the control loops or advanced control technology like “Model Predictive Control” to improve the process performance.

The above analysis analyses the process performance, identify gaps and evaluate potential for improvements in design/operation.

Therefore, the disclosure not only provides a method and a system for energy benchmarking through optimization on one part but also diagnosis for the gap between the current energy consumption of the process plant and the estimated energy benchmark. Hence, the disclosure provides a solution to address the problem associated with the rightful approach for energy benchmarking for the process plant and diagnosing the gap thereof accordingly.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for energy benchmarking a process plant having at least one component, the method comprising:
adapting a process model for said process plant;
determining an energy consumption of the process plant based on at least one of design conditions and current operating conditions; and
performing an optimization of the energy consumption to estimate an energy benchmark.

2. A method for energy benchmarking a process plant having at least one component and for diagnosing said process plant, the method comprising:
adapting a process model for said process plant;
determining an energy consumption of said process plant based on at least one of design conditions and current operating conditions;
performing an optimization of the energy consumption to estimate an energy benchmark;
calculating indices for gap analysis; and
diagnosing a gap between said current energy consumption of said process plant and said estimated energy benchmark.

3. The method as claimed in claim 1, wherein the step of adapting said process model includes relating the energy consumption of said process plant to the current operating conditions.

4. The method as claimed in claim 1, wherein the step of determining energy consumption includes employing design conditions such as design values of said process plant that correspond to at least one of yield and energy coefficients.

5. The method as claimed in claim 1, wherein the step of determining energy consumption includes employing current operating conditions such as current operating values of the process variables of said process plant that correspond to at least one of yield and energy coefficients.

6. The method as claimed in claim 1, wherein the step of performing optimization for estimating energy benchmark includes at least one of using constraints of at least one of the equipment, and said process plant, and using said process model for estimating energy benchmark.

7. The method as claimed in claim 2, wherein the step of diagnosing the gap includes using said indices for reducing the gap between said current energy consumption of said process plant and said estimated energy benchmark.

8. The method as claimed in claim 2, wherein the step of diagnosing includes comparing the values purporting to at least one of yield, energy and coefficients of at least one design conditions and of current operating conditions, and current process variables, correspondingly with values of yield or energy coefficients or process variables obtained through optimization.

9. The method as claimed in claim 8, wherein the step of diagnosing further includes controlling at least one of said equipment and said process plant based on said comparison and improvement thereupon through at least one of maintenance and operation of said at least one equipment and process plant.

10. A system for energy benchmarking and providing a diagnosis of a process plant having at least one component, the system comprising:
a processor configured to execute a process model of said process plant;
an energy consumption determination component configured to determine energy consumption of said process plant based on at least one of design conditions and current operating conditions;
an optimization module configured to perform optimization for estimating energy benchmark; and
a diagnosis module configured to calculate indices for gap analysis and diagnose the gap between said current energy consumption said process plant and said estimated energy benchmark.
